(19) United States
(12) Patent Application Publication
(10) Pub. No.: US 2006/0016283 A1
(43) Pub. Date: Jan. 26, 2006

(54) Torque limiter, and garbage dewatering apparatus using the same

(76) Inventors: Junji Owa, Nagano (JP); Kazuki Hoshi, Nagano (JP); Kazunori Nishikawa, Nagano (JP)

Correspondence Address: CANTOR COLBURN, LLP, 55 GRIFFIN ROAD SOUTH, BLOOMFIELD, CT, 06002, US

(21) Appl. No.: 11/185,366

(22) Filed: Jul. 20, 2005

(30) Foreign Application Priority Data
Jul. 20, 2004 (JP) 2004-211240
Jul. 4, 2005 (JP) 2005-195093

(51) Int. Cl. F16H 35/00

(52) U.S. Cl. 74/380

(57) ABSTRACT

Disclosed herein is a torque limiter device which is provided with an inner ring and an outer ring and the inner ring and the outer ring operate together to transmit an input torque to an output member constituted of one of the inner ring and the outer ring as long as the torque is not more than a set torque. One of the input member and the output member is provided with an engagement groove, and the other of the input member and the output member is provided with a coil spring for pressing into the engagement groove an engaging member which is to engage with the engagement groove. When the input torque applied to the input member exceeds the set torque level, the engaging member deforms the coil spring to disengage from the engagement groove, resulting in the input torque not being transmitted to the output member.

### CROSS REFERENCE TO RELATED APPLICATION

The present invention claims priority under 35 U.S.C. §119 to the following, Japanese Application No. 2004-211240 filed Jul. 20, 2004, to Japanese Application No. 2005-188862 filed Jun. 28, 2005 and Japanese Application No. 2005-195093 filed Jul. 4, 2005, all of which are incorporated herein by reference.

### BACKGROUND OF THE INVENTION

1. Field of the Invention

The present invention relates to a torque limiter which outputs an input torque in a case where the input torque is not more than a set torque and which does not output any torque in a case where the input torque exceeds the set torque, and a garbage dewatering apparatus using this limiter. More particularly, the present invention relates to a torque limiter using a spring force, and a garbage dewatering apparatus using this limiter.

2. Description of the Related Art

As a torque limiter, there is a limiter which operates an input member and an output member together via a frictional force and which generates slippage between the input member and the output member to prevent the operation, when a torque which is not less than a predetermined frictional force is applied to the input member. As another example of the torque limiter, there is a limiter in which a high-viscosity oil is disposed between the input member and the output member to operate them together.

Furthermore, a one-way clutch is sometimes utilized as another example of the torque limiter. For example, a torsional coil spring or a needle bearing is disposed in a connecting portion between two shafts, and two shafts do not operate together, when one shaft rotates in a certain direction. However, when the shaft rotates in a reverse direction, the torsional coil spring or the needle bearing abuts on the other shaft so that two shafts operate together. Such one-way clutch is used as the torque limiter.

However, in the torque limiter using the above-described frictional force between the components, since the components are rubbed against each other, a life of the limiter is short, maintenance has to be frequently performed, and management is complicated. In the torque limiter using the oil, since the viscosity of the oil is easily influenced by temperature, use conditions are limited, or setting or managing of the frictional force is complicated.

Furthermore, in the torque limiter using the one-way clutch, since only the rotation in one direction functions as the torque limiter, the torque limiter cannot be used in the opposite direction. To use this torque limiter in the opposite direction, two one-way clutches are used, or a complicated mechanism has to be disposed. Therefore, an apparatus is enlarged, or costs increase.

Moreover, in any one of these torque limiters, positioning between the input member and the output member is not considered. Therefore, to position these members, a stopper member for positioning or the like has to be disposed separately from the torque limiter.

Therefore, a problem in the current art is to provide a torque limiter which is easy to manage and which can be used in opposite rotating directions and which also has a positioning function, and a garbage dewatering apparatus using this limiter.

### SUMMARY OF THE INVENTION

To solve the above-described problem, according to an embodiment of the present invention, there is provided a torque limiter which is provided with an inner ring and an outer ring and in which the inner ring and the outer ring operate together to transmit an input torque to an output member constituted of one of the inner ring and the outer ring in a case where the input torque applied to an input member constituted of the other of the inner ring and the outer ring is not more than a set torque, wherein one of the input member and the output member is provided with an engagement groove; the other of the input member and the output member is provided with a coil spring for pressing into the engagement groove an engaging member which is to engage with the engagement groove; and when the input torque applied to the input member exceeds the set torque, the engaging member elastically deforms the coil spring to disengage from the engagement groove, the inner ring and the outer ring are brought into a state in which the rings do not operate together, whereby the input torque is not transmitted to the output member.

In an embodiment of the present invention, since the transmission and the non-transmission of the torque are switched by an urging force of the coil spring, the limiter is not easily influenced by wear as compared with a conventional case where a frictional force between components is used. The limiter is not easily influenced by temperature as compared with a conventional case where a viscosity of oil is used.

Furthermore, although the number of components is small, the limiter is usable as an opposite-direction torque limiter. When the engaging members engage with the engagement grooves, the torque limiter functions. Therefore, the limiter can have a function of positioning the inner ring and the outer ring.

In an embodiment of the present invention, there are provided a plurality of engagement grooves. Moreover, the other of the input member and the output member has a plurality of engagement portions which engage with the engaging members in positions corresponding to the plurality of engagement grooves. The plurality of engaging members which engage with the respective engagement portions preferably elastically deform the coil spring to disengage from the engagement grooves, and engage with the engagement portions to operate together with the other of the input member and the output member, when the input torque applied to the input member exceeds the set torque. By this constitution, the plurality of engaging members can simultaneously engage or disengage with respect to the plurality of engagement grooves. Therefore, a degree of freedom of the set torque can be enhanced, and the set torque is stabilized.

In an exemplary embodiment of the present invention, the inner ring and the outer ring are concentrically and adjacently disposed around a rotation center, and the inner ring and the outer ring relatively rotate with respect to each other, when the input torque applied to the input member exceeds the set torque. The plurality of engagement grooves are arranged, for example, along a peripheral direction of one of the input member and the output member, and after the relative rotation, the engaging members engage with the engagement grooves which are different from those before the relative rotation. In this case, the plurality of engaging members are preferably arranged at equal intervals in the peripheral direction. By this constitution, since a diameter of the coil spring can be enlarged in the peripheral direction with a good balance by the plurality of engaging members, the transmitted torque can be stabilized, and precision of the torque limiter can be secured.

In an embodiment of the present invention, the engaging members are preferably roller pins. In general, since the roller pins themselves are rigid, by this constitution, the inner ring and the outer ring can be securely operated together in a case where the input torque is not more than the set torque. Since the roller pins are formed into columnar shapes, the roller pins can be smoothly removed without being caught by edges of the engagement grooves or the like in a case where the input torque exceeds the set torque, and the roller pins are removed from the engagement grooves. Therefore, fluctuations in the transmitted torques among individuals can be reduced.

In an embodiment of the present invention, the coil spring is preferably constituted of a plurality of coil springs. By this constitution, a total movement of divided coil springs is equal to a movement of one continuous coil spring having an axial dimension which is equal to a total axial dimension of the divided coil springs juxtaposed in an axial direction, but the movement of one of the divided coil springs can be reduced. Therefore, a life of the coil spring comprising the divided coil springs can be lengthened as compared with the continuous coil spring.

In an embodiment of the present invention, the coil spring is wound around an outer wall of the outer ring, the engagement grooves are grooves formed in an outer wall of the inner ring, the engagement portions are through holes formed in a radial direction of the outer ring, and the engaging members move to the outside of the radial direction in the through holes against an urging force of the coil spring to thereby disengage from the engagement grooves.

As described above, according to the torque limiter of an embodiment of the present invention, since the transmission and the non-transmission of the torque are switched by the urging force of the coil spring, components wear less, and durability can be enhanced as compared with a conventional case where a frictional force between components is used. Since the limiter is not easily influenced by temperature as compared with a conventional case where a viscosity of oil is used, and usable conditions can be broadened.

Furthermore, although the number of components is small, the limiter is usable as an opposite-direction torque limiter. When the engaging members engage with the engagement grooves, the torque limiter functions. Therefore, the limiter can have a function of positioning the inner ring and the outer ring.

### BRIEF DESCRIPTION OF THE DRAWINGS

FIG. 1(A), FIG. 1(B) and FIG. 1(C) are; a laterally cut sectional view cut along a line A-A of (B) in positioned states of outer and inner ring members of a torque limiter to which an embodiment of the present invention is applied, a longitudinally cut sectional view cut along a line B-B of (A), and a laterally cut sectional view in idling states of the outer and inner ring members, respectively.

FIG. 2 is an exploded perspective view of members constituting the torque limiter to which the an exemplary embodiment of the present invention is applied as viewed obliquely from above.

FIG. 3 is an exploded perspective view of a garbage dewatering apparatus using the torque limiter of an embodiment of the present invention.

### DESCRIPTION OF THE PREFERRED EMBODIMENTS

An exemplary embodiment for carrying out the present invention will be described hereinafter with reference to the drawings.

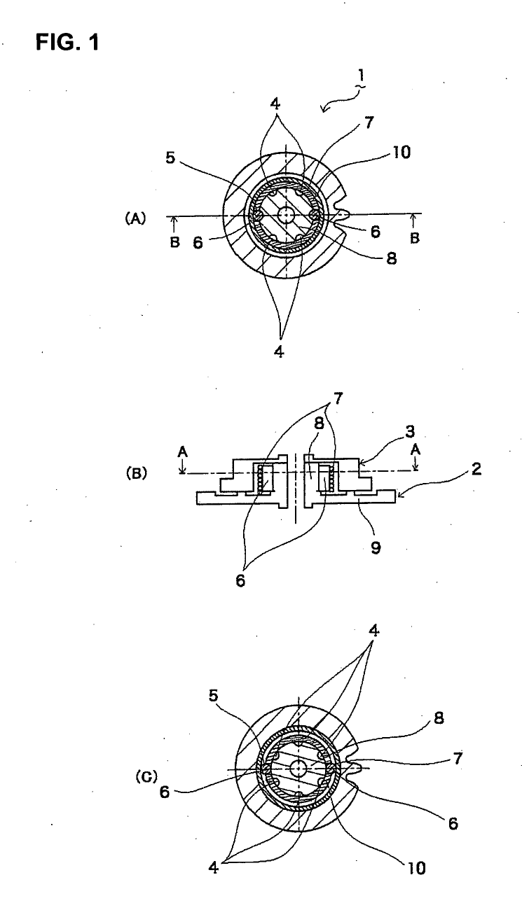

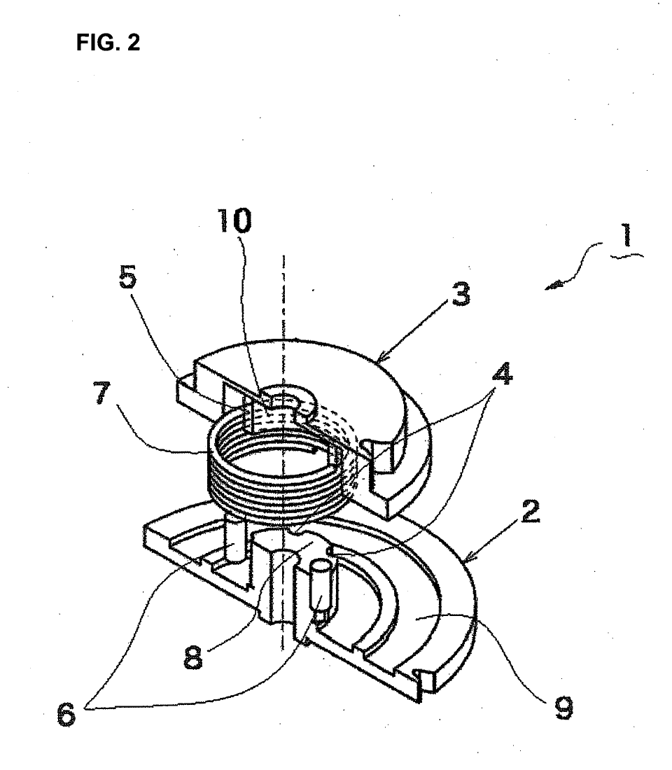

FIGS. 1(A), (B), (C) are; a laterally cut sectional view cut along a line A-A of (B) in positioned states of outer and inner ring members of a torque limiter to which an embodiment of the present invention is applied, a longitudinally cut sectional view cut along a line B-B of (A), and a laterally cut sectional view in idling states of the outer and inner ring members, respectively. FIG. 2 is an exploded perspective view of members constituting the torque limiter to which an embodiment of the present invention is applied as viewed obliquely from above.

FIGS. 1 and 2 show one embodiment of a torque limiter 1 of the present invention. The torque limiter 1 is provided with an inner ring member 2 and an outer ring member 3. When an input torque applied to an input member constituted of one of the inner ring member 2 and the outer ring member 3 is not more than a set torque, the input torque is transmitted to an output member constituted of the other of the inner ring member 2 and the outer ring member 3. In this embodiment of a torque limiter 1, six engagement grooves 4 are formed in the inner ring member 2, and a coil spring 7 for pressing roller pins 6 as engaging members which engage with the engagement grooves 4 into the engagement grooves 4 is wound around an outer wall of the outer ring member 3.

In the present embodiment, two engagement portions 5 are formed in the outer ring member 3, and two roller pins 6 are constituted to engage with the engagement grooves 4 and the engagement portions 5. Moreover, when the input torque applied to the input member exceeds the set torque, the roller pins 6 elastically deform the coil spring 7, and move to the outside of a radial direction to disengage from the engagement grooves 4, and the inner ring member 2 and the outer ring member 3 are brought into a state in which the members do not operate together. It is to be noted that, in the present embodiment, the engagement grooves 4 are formed in the inner ring member 2, but may be formed in the outer ring member 3. In this case, the inner ring member 2 is provided with the coil spring 7 as well as the engagement portions.

The inner ring member 2 is provided with a cylindrical portion (inner ring) 8 and a flange portion 9. The outer ring member 3 is provided with a fitting peripheral wall portion (outer ring) 10 which rotatably fits into a periphery of the cylindrical portion 8 of the inner ring member 2. When an inner wall of the fitting peripheral wall portion 10 of the outer ring member 3 slides on an outer wall of the cylindrical portion 8 of the inner ring member 2, the inner ring member 2 and the outer ring member 3 relatively rotate with respect to each other. As to the engagement portions 5, two portions of the fitting peripheral wall portion 10 are cut so that the roller pins 6 are movable in the radial direction. It is to be noted that the engagement portions 5 are formed at an interval of 180 degrees in a peripheral direction. The engagement grooves 4 are formed in six portions of an outer peripheral surface of the cylindrical portion 8 at an interval of about 60 degrees. Therefore, the inner ring member 2 and the outer ring member 3 are positioned in such a manner as to be fixed every 60 degrees.

In an embodiment The coil spring 7 has an annular shape formed by winding a metal wire eight times, and a projected surface viewed from an axial direction has a circular shape. This coil spring 7 is wound around the outer wall of the fitting peripheral wall portion 10 of the outer ring member 3 in such a manner as to cover each engagement portion 5, and is constituted to cover two engagement portions 5 simultaneously.

The roller pins 6 are disposed inside the respective engagement portions 5, and urged inwards by the coil spring 7.

Next, an example of an operation of the above-described torque limiter 1 will be described.

When two roller pins 6, engage with two engagement grooves 4, as shown in FIG. 1, and the input torque is not more than the set torque, the cylindrical portion 8 of the inner ring member 2 is connected to the fitting peripheral wall portion 10 of the outer ring member 3 via the roller pins 6, and the members can be rotated together while maintaining a state in which the inner ring member 2 and the outer ring member 3 are positioned. Moreover, when a large torque is applied between the inner ring member 2 and the outer ring member 3, edges of two engagement grooves 4, simultaneously press two roller pins 6, outwards, and the roller pins 6, are pushed out of the engagement grooves 4, against the coil spring 7. As a result, the inner ring member 2 and the outer ring member 3 idle because the positioned state cannot be maintained.

It is to be noted that even after the roller pins 6, are pushed out of the engagement grooves 4, the pins engage with the engagement portions 5. Therefore, the pins rotate in conjunction with the outer ring member 3 while maintaining an interval of 180 degrees. Here, the engagement grooves 4 are formed at an interval of about 60 degrees in six portions of the outer peripheral surface of the cylindrical portion 8. Therefore, the engagement grooves 4, are disposed in point symmetric positions of 180 degrees with respect to a center of the cylindrical portion. When the roller pins 6, are pushed out of the engagement grooves 4, against the coil spring 7 to disengage therefrom, and further rotate by 60 degrees, two roller pins 6, maintained at an interval of 180 degrees by the engagement portions 5 are engaged with the adjacent engagement grooves 4, respectively. While a large torque is applied, the engagement and the disengagement are repeatedly performed in this manner by the roller pins 6, and the engagement grooves 4.

Finally, when the torque decreases, that is, when it is not more than the set torque, and the roller pins 6 reach the engagement grooves 4, their inserted states are maintained by the urging force of the coil spring 7, and the inner ring member 2 and the outer ring member 3 are again positioned and rotatably operated together.

Next, an embodiment will be described in which the above-described torque limiter 1 is used in a garbage dewatering apparatus.

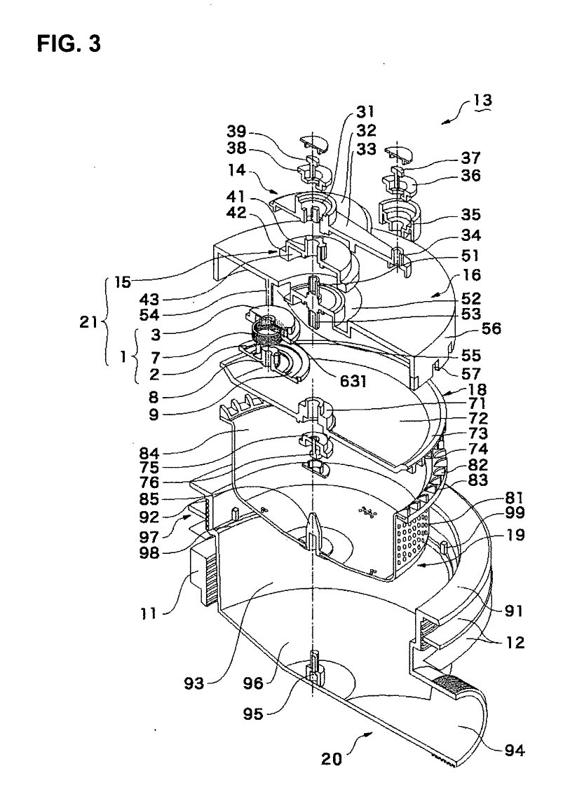

FIG. 3 is an exploded perspective view of the garbage dewatering apparatus using the torque limiter in an embodiment of the present invention.

A garbage dewatering apparatus 13 is attached to a drain port of a sink bottom portion of a sink cabinet installed in a kitchen. This garbage dewatering apparatus 13 mainly comprises: a bottomed cylindrical housing member 20 which is a housing section opened and attached to the drain port; a bottomed cylindrical drainer 19 which is completely housed in the housing member 20 and which receives garbage falling from the drain port; and a lid 16 which covers the drainer 19 during dewatering and which is provided with a manual lever 14 as driving means for rotating and driving the drainer 19.

As shown in FIG. 3, in the housing member 20, an opening side of a cylindrical side wall 93 is bent outwards by 90 degrees to constitute a flange portion 91. The opening side of the side wall 93 constitutes a large-diameter portion 97, and, in an outer periphery thereof, a male screw 92 is formed adjacent to the flange portion 91. Furthermore, a stepped portion 98 is formed on an inner peripheral side, and a plurality of protruding portions 99 extending from the stepped portion 98 in the axial direction are formed along an inner periphery. Moreover, this housing member 20 is tightly attached to the bottom portion in the sink, when a nut 11 engaged with the male screw 92 is tightened in a peripheral edge portion of the drain port in such a manner that the flange portion 91 is allowed to abut on an upper surface of the member and annular sealing materials 12 are held from a lower surface thereof. On the other hand, a cylindrical draining portion 94 connected to a drain pipe is protruded outwards from a bottom portion of the cylindrical side wall 93.

The drainer 19 which receives the garbage falling from the drain port is completely housed inside the housing member 20, and a rotary shaft hole 85 described later horizontally rotatably engages with a shaft support protrusion 95 protruded substantially from a middle of a bottom portion 96 of the housing member 20.

The drainer 19 is formed into a bottomed cylindrical shape whose upper surface opens by use of a punched metal. Therefore, a large number of circular dewatering holes 81 are formed in the whole surface of a cylindrical side wall 84. As to the drainer 19, an upper end of the side wall 84 on the opening side is bent outwards by 90 degrees to constitute a flange portion 83, and uneven portions 82 are formed on an upper surface of the drainer. A bottom portion middle of the drainer 19 is protruded inwards, and the above-described rotary shaft hole 85 opening downwards is formed to engage with the shaft support protrusion 95.

The drain port is provided with the lid 16 to cover the drainer 19 which is attached during the dewatering, and the lid 16 is provided with: the manual lever 14 which is driving means; a speed increasing ring row 21 mechanically connected to the manual lever 14; and a rotary disc 18 mechanically connected to the speed increasing ring row 21 and rotatably connected to the drainer 19.

The lid 16 is formed into a bottomed cylindrical shape whose lower surface opens, and a plurality of recessed portions 57 extending from an opening in the axial direction are formed along an outer periphery. To remove water, when a cylindrical side wall 56 of the lid 16 is inserted along an inner periphery of the large-diameter portion 97 of the housing member 20, the protruding portions 99 engage with the recessed portions 57, and the lid 16 is accordingly prevented from being rotated in the peripheral direction.

A shaft support protrusion 51 is protruded as an upper support portion from a center of the upper surface of the lid 16, an annular recessed portion 52 is disposed in such a manner as to surround the shaft support protrusion 51, and a part of the side wall outside a diametric direction forms a cutout portion 55 cut in such a manner as to connect the upper surface of the lid 16 to a lower surface thereof.

Moreover, on the lower surface of the lid 16, a shaft support protrusion 53 is protruded as a lower support portion coaxially with the shaft support protrusion 51. Furthermore, outside the diametric direction in the vicinity of the cutout portion 55, a shaft support protrusion 54 is protruded substantially in parallel with the shaft support protrusion 53.

The speed increasing ring row 21 comprises a driving gear 15 and the torque limiter 1. The driving gear 15 is formed into a bottomed cylindrical shape, a small-diameter protruding portion 41 is protruded upwards from a middle of a bottom portion upper surface, and an inner peripheral side of the protruding portion is rotatably supported by the shaft support protrusion 51 protruded from the upper surface of the lid 16. A serration is formed on an outer peripheral side. It is to be noted that the opening side of a side wall 43 formed into a cylindrical shape is housed in the recessed portion 52, a lower end of the side wall is bent outwards by 90 degrees to form a flange portion 42, and teeth portions are formed on an outer periphery of the side wall to face the cutout portion 55.

On the other hand, in the cutout portion 55, the outer ring member 3 of the torque limiter 1 is provided with teeth portions which engage with those formed on the outer periphery of the flange portion 42 of the driving gear 15, and the outer periphery of the flange portion 9 of the inner ring member 2 is provided with teeth portions which engage with those formed on the outer periphery of a small-diameter protrusion 71 of the rotary disc 18 described later. The shaft support protrusion 54 is inserted through the cylindrical portion 8 on an inner peripheral side thereof so that the torque limiter 1 is rotatably supported. It is to be noted that in the present embodiment, the outer ring member 3 constitutes the input member.

The rotary disc 18 comprises the small-diameter protrusion 71, and a flange portion 72 extended from the small-diameter protrusion 71 in the diametric direction. In a state in which teeth portions formed on the outer periphery of the small-diameter protrusion 71 engage with those formed on the outer periphery of the flange portion 9 of the torque limiter 1, the shaft support protrusion 53 is inserted into the small-diameter protrusion 71 on an inner peripheral side thereof. The disc is fixed by a screw 76 via a washer 75 from above, and supported rotatably around the shaft support protrusion 53.

A peripheral end of the flange portion 72 of the rotary disc 18 tilts upwards by about 45 degrees to form a tilted peripheral edge portion 73, and uneven portions 74 which engage with the uneven portions 82 of the drainer 19 are formed below a lower surface of the tilted peripheral edge portion 73. Therefore, during the dewatering, rotation of the rotary disc 18 is transmitted to the drainer 19 via the uneven portions 74 and 82. It is to be noted that even in a case where protruding portions hit each other during the engagement of the uneven portions 82 and 74, the rotation of the rotary disc 18 is permitted by the torque limiter 1, the uneven portions 74 therefore move to positions where the portions can engage with the uneven portions 82, and the portions can smoothly engage with each other.

The manual lever 14 mainly comprises: a cylindrical portion 31 provided with a serration on an inner peripheral side thereof, and engaged with and serration-connected to the serration formed on the outer peripheral side of the small-diameter protruding portion 41 of the driving gear 15; a flange portion 32 extended from a lower end of the cylindrical portion 31 to the outside of the radial direction to cover the driving gear 15; and a lever section 33 extended from the cylindrical portion 31 to the outside of the radial direction of the flange portion 32. On a tip of the lever section 33, a shaft support protrusion 34 is protruded in the axial direction which rotatably supports a knob 35. The shaft support protrusion 34 is inserted into the knob 35 on an inner peripheral side thereof, and the knob is fixed by a screw 37 via a washer 36 from above, and rotatably supported around the shaft support protrusion 34. In this manual lever 14, the flange portion 32 is disposed in such a manner as to cover the driving gear 15, and the cylindrical portion 31 is serration-connected to the small-diameter protrusion 41 of the driving gear 15. In this state, the lever is fixed by a screw 39 via a washer 38 from above. Accordingly, both of the components 14, 15 are prevented from being detached, and integrated. When the manual lever 14 is turned, the driving gear 15 is integrally rotated. In this case, the knob 35 can freely rotate in accordance with the rotation of the manual lever 14.

In the garbage dewatering apparatus 13 of an embodiment of the present invention, the knob 35 of the manual lever 14 disposed on the middle of the upper surface of the lid 16 is manually held and rotated horizontally. Accordingly, the rotation of the manual lever 14 is transmitted to the driving gear 15 by the serration connection, and further transmitted to the rotary disc 18 via the torque limiter 1 so that the rotary disc 18 is rotated at a high speed. Since the rotation of the rotary disc 18 is transmitted to the drainer 19 via the uneven portions 74 and 82, the drainer rotates integrally with the rotary disc 18 at the high speed. That is, in the drainer 19, since a speed of the rotation of the manual lever 14 is increased about six times by the speed increasing ring row 21, large water removing effects can be obtained.

As described above, in the torque limiter 1 of an embodiment according to the present invention, the transmission and the non-transmission of the torque are switched by the urging force of the coil spring 7. Therefore, the components wear less and durability can be enhanced as compared with a conventional case where the frictional force between the components is used. Since the limiter is not easily influenced by temperature as compared with a conventional case where a viscosity of oil is used, usable conditions can be broadened. Furthermore, although the number of the components is small, the limiter is usable as an opposite-direction torque limiter. When the roller pins 6 engage with the engagement grooves 4, the torque limiter functions. Therefore, the limiter can have a function of positioning the inner ring member 2 and the outer ring member 3.

In an embodiment, the inner ring member 2 has six engagement grooves 4, and the outer ring member 3 has two engagement portions 5. When the input torque applied to the outer ring member 3 exceeds the set torque, two roller pins 6 engaging with the engagement portions 5, respectively, move to the outside, elastically deform the coil spring 7 to disengage from the engagement grooves 4, and engage with the engagement portions 5 to operate together with the outer ring member 3. Therefore, two roller pins 6 can be simultaneously engaged or disengaged with respect to two engagement grooves 4. Therefore, as compared with a case where one roller pin 6 is disposed, a degree of freedom of the set torque can be enhanced, and the set torque is stabilized.

In an embodiment, the cylindrical portion (inner ring) 8 and the fitting peripheral wall portion (outer ring) 10 are concentrically and adjacently disposed around the rotation center. When the input torque applied to the outer ring member 3 exceeds the set torque, the outer wall of the cylindrical portion 8 slides on the inner wall of the fitting peripheral wall portion 10, and the inner ring member 2 and the outer ring member 3 relatively rotate with respect to each other. Especially, six engagement grooves 4 are arranged along the peripheral direction of the inner ring member 2, and, after the relative rotation, the roller pin 6 engages with the engagement groove 4 disposed adjacent to the engagement groove 4 before the relative rotation. It is to be noted that since two roller pins 6 are disposed at the equal interval in the peripheral direction, the diameter of the coil spring 7 can be enlarged in the peripheral direction with good balance by two roller pins 6, therefore the transmitted torque is stabilized, and precision of the torque limiter 1 can be secured.

It is to be noted that, in general, since the roller pins 6 are rigid, by this constitution, the inner ring member 2 can be securely operated together with the outer ring member 3 in a case where the input torque is not more than the set torque. Moreover, since the roller pins 6 can be smoothly removed without being caught by the edges of the engagement grooves 4 or the like in a case where the input torque exceeds the set torque, fluctuations among individuals can be reduced.

In the garbage dewatering apparatus 13 of the present embodiment, the torque limiter 1 constituted of the coil spring 7, the outer ring member 3, and the inner ring member 2 is disposed in the speed increasing ring row 21 which transmits an output from the manual lever 14 to the drainer 19. Therefore, even when the knob 35 or the like is touched during the rotating of the manual lever 14 by an inertial force of the drainer 19, or a tableware piece is accidentally placed in a rotation locus of the manual lever 14, the rotation by the inertial force of the drainer 19 is interrupted by the torque limiter 1, and any disadvantage is not generated. The speed of the rotation of the manual lever 14 is increased about six times, and the rotation is transmitted to the drainer 19 by the speed increasing ring row 21, but the manual lever 14 needs to be rotated at 100 rpm for about 20 seconds as a dewatering operation. If the rotation speed of the manual lever 14 is lowered during the rotation, the drainer 19 rotating by the inertial force is braked. In an embodiment, even when the rotation speed of the manual lever 14 is lowered, the drainer 19 rotating by the inertial force is not braked by the torque limiter 1 if the torque exceeds the set torque level. Furthermore, since any large load is not applied to the speed increasing ring row 21, gears constituting the speed increasing ring row 21 can be thinned.

Moreover, since the torque limiter 1 having less wear is used as compared with the conventional technique, life or maintenance interval of the garbage dewatering apparatus 13 can be extended. Furthermore, by use of the torque limiter 1 which is not easily influenced by the temperature as compared with the conventional technique, it is possible to obtain the garbage dewatering apparatus 13 which is usable on broader conditions.

It is to be noted that the above-described embodiment is one example of exemplary embodiments of the present invention, but the present invention is not limited to this, and can be variously modified within a range which does not depart from the scope of the present invention. For example, in the above-described embodiment, the engagement grooves 4, the engagement portions 5, and the coil spring 7 are arranged in order from the inside, and the coil spring 7 urges the roller pins 6 inwards, but the present invention is not limited to this. The engagement grooves 4, the engagement portions 5, and the coil spring 7 may be disposed in order from the outside, and the coil spring 7 may urge the roller pins 6 outwards.

Moreover, the above-described embodiment is provided with six engagement grooves 4, two engagement portions 5, and two roller pins 6, but the present invention is not limited to this.

Furthermore, in the above-described embodiment, the roller pins 6 are used as engaging members, but the members are not necessarily limited to the roller pins 6. For example, spherical engaging members may be used.

Additionally, the projected surface of the coil spring 7 is circular in the above-described embodiment, but the present invention is not limited to this, and the projected surface may be elliptical or polygonal. That is, by use of the elliptical surface, while a material of the coil spring 7, the number of winding times of the coil spring 7 and the like remain to be unchanged, the set torque of the torque limiter 1 can be easily changed. For example, when the projected surface of the coil spring 7 is set to be elliptical, the roller pins 6 are urged inwards on a long-diameter side of the coil spring 7. Accordingly, two roller pins 6, may easily disengage from the engagement grooves 4, and may not easily engage with the engagement grooves 4. When the roller pins 6 are urged inwards on a short-diameter side of the coil spring 7, two roller pins 6, may not easily disengage from the engagement grooves 4, and may easily engage with the engagement grooves 4.

Moreover, a lateral section of the metal wire itself constituting the coil spring 7 may be either a circular section or an angular section. In general, by use of the angular section, since the coil spring 7 is strong against a stress, it is possible to obtain the set torque equal to that of the coil spring 7 having less winding times than the circular section, and a compact structure is possible.

Furthermore, in the above-described embodiment, when the input torque applied to the outer ring member 3 exceeds the set torque, the outer wall of the cylindrical portion 8 slides on the inner wall of the fitting peripheral wall portion 10, and the inner ring member 2 and the outer ring member 3 relatively rotate with respect to each other. However, the outer wall of the cylindrical portion 8 do not necessarily have to slide on the inner wall of the fitting peripheral wall portion 10. That is, the walls may be slid on another portion in a case where dimensional precisions of the outer wall of the cylindrical portion 8 and the inner wall of the fitting peripheral wall portion 10 cannot be secured.

Additionally, in the present embodiment, the metal wire constituting the coil spring 7 is continuously wound eight times, but the number of winding times of the coil spring 7 is not limited to eight. That is, the wire may be wound once to ten or more times, further several tens of times. The metal wire constituting the coil spring 7 does not have to be continuously wound. For example, when the wire is wound eight times, four metal wires each wound twice may be juxtaposed in the axial direction. When the divided coil springs are juxtaposed in the axial direction, a dimension of the axial direction is equal to that of the continuous coil spring continuously wound eight times. Therefore, the total movement of four divided coil springs is equal to the movement of the continuous coil spring, but the movement of each coil spring is ¼. Therefore, the movement of one coil spring can be reduced. Therefore, by use of the divided coil springs, the life of the coil spring 7 can be extended as compared with the continuous coil spring.

What is claimed is:

1. A torque limiter comprising an inner ring and an outer ring and in which the inner ring and the outer ring operate together to transmit an input torque to an output member constituted of one of the inner ring and the outer ring in a case where the input torque applied to an input member constituted of the other of the inner ring and the outer ring is not more than a set torque, wherein one of the input member and the output member is provided with at least one engagement groove; the other of the input member and the output member is provided with a coil spring for pressing into the engagement groove at least one engaging member which is to engage with the engagement groove; and in response to the input torque applied to the input member exceeding the set torque, the engaging member elastically deforms the coil spring to disengage from the engagement groove, the inner ring and the outer ring are brought into a state in which the rings do not operate together, whereby the input torque is not transmitted to the output member.

2. The torque limiter according to claim 1, further comprising the plurality of engagement grooves, wherein one of the input member and the output member has a plurality of engagement portions which engage with the engaging members in positions corresponding to the plurality of engagement grooves; and in response to the input torque applied to the input member exceeding the set torque, the plurality of engaging members which engage respectively with the engagement portions elastically deform the coil spring to disengage from the engagement grooves and to engage with the engagement portions, whereby the engaging members operate together with one of the input member and the output member.

3. The torque limiter according to claim 1, wherein the inner ring and the outer ring are concentrically and adjacently disposed around a rotation center, and the inner ring and the outer ring relatively rotate with respect to each other, when the input torque applied to the input member exceeds the set torque.

4. The torque limiter according to claim 3, wherein the plurality of engagement grooves are arranged along a peripheral direction of the other of the input member and the output member, and after the relative rotation, the engaging members engage with the engagement grooves which are different from the engagement grooves before the relative rotation.

5. The torque limiter according to claim 3, wherein the plurality of engaging members are arranged at equal intervals in the peripheral direction.

6. The torque limiter according to claim 1, wherein the engaging members are roller pins.

7. The torque limiter according to claim 1, wherein the coil spring is constituted of a plurality of coil springs.

8. The torque limiter according to claim 1, wherein the coil spring is wound around an outer wall of the outer ring.

9. The torque limiter according to claim 8, wherein the engagement grooves are grooves formed in an outer wall of the inner ring, the engagement portions are through holes formed in a radial direction of the outer ring, and the engaging members move to the outside of the radial direction in the through holes against an urging force of the coil spring to thereby disengage from the engagement grooves.

10. A garbage dewatering apparatus using the torque limiter according to claim 1.
